(19) United States
(12) Patent Application Publication
(10) Pub. No.: US 2014/0123806 A1
(43) Pub. Date: May 8, 2014

(54) DOUBLE CLUTCH POWERTRAIN FOR VEHICLE

(71) Applicant: Hyundai Motor Company, Seoul (KR)

(72) Inventors: Seung Ho LEE, Seoul (KR); Jong Min KIM, Hwaseong-si (KR); Hyung Wook CHO, Ansan-si (KR); Sang Won SEO, Seoul (KR); Jong Sool PARK, Hwaseong-si (KR); Byeong Wook JEON, Seoul (KR); Joung Chul KIM, Suwon-si (KR); Chang Yeon CHO, Seoul (KR)

(73) Assignee: Hyundai Motor Company, Seoul (KR)

(21) Appl. No.: 14/026,244

(22) Filed: Sep. 13, 2013

(30) Foreign Application Priority Data
Nov. 8, 2012 (KR) 10-2012-0126219

(51) Int. Cl. F16D 21/02; B60K 6/50

(52) U.S. Cl. CPC F16D 21/02; B60K 6/50; Y10S 903/902
USPC 74/661; 180/65.22; 903/902

(57) ABSTRACT

A double clutch powertrain for a vehicle makes smooth starting of the vehicle and smooth gear shifting possible despite using a dry type double clutch and makes regenerative braking and power generation possible when the vehicle decelerates, thus improving the driving characteristics of the vehicle, and enhancing the fuel efficiency of the vehicle.

### CROSS-REFERENCE TO RELATED APPLICATION

The present application claims priority of Korean Patent Application Number 10-2012-0126219 filed Nov. 8, 2012, the entire contents of which application is incorporated herein for all purposes by this reference.

### BACKGROUND OF INVENTION

1. Field of Invention

The present invention relates generally to powertrains for vehicles and, more particularly, to a gear shift mechanism for a vehicle using a double clutch.

2. Description of Related Art

Double clutch transmissions use the existing manual transmission mechanism and are provided two clutches to increase the power transmission efficiency and, particularly, prevent torque from being reduced when shifting gears. The use of double clutch transmissions is becoming increasingly common.

However, the typical double clutch transmissions use dry type clutches. Therefore, in a starting or gear shift operation of a vehicle, for reasons such as a limit of thermal capacity, etc., it is difficult for the vehicle to be smoothly started. Particularly, when starting a vehicle facing uphill, there is the possibility of the vehicle being pushed rearwards because of a clutch slip phenomenon. Moreover, there is a problem of shifting shock, etc. resulting from reduced shift time.

An exemplar of the prior art is Korean Patent Application Publication No. KR 1020100064726 A.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, the present invention has been made keeping in mind the above problems occurring in the prior art.

Various aspects of the present invention provide for a double clutch powertrain for a vehicle which makes smooth starting and smooth gear shifting possible despite using a dry type double clutch and makes regenerative braking and power generation possible when the vehicle decelerates, thus improving the driving characteristics of the vehicle, and enhancing the fuel efficiency of the vehicle.

Various aspects of the present invention provide for a double clutch powertrain for a vehicle, including: a first input shaft configured to intermittently receive power from a power source; a second input shaft provided coaxially with the first input shaft and configured to intermittently receive power from a power source; and a motor generator provided to transmit power to the first input shaft and receive power therefrom, wherein the first input shaft and the second input shaft, along with a separate gear shift apparatus, alternately form gear stages determined depending on a series of gear ratios, and either the first input shaft or the second input shaft forms a reverse-gear stage.

In other aspects, the present invention provides a double clutch powertrain for a vehicle, including: a first input shaft configured to intermittently receive power from a power source; a second input shaft comprising a hollow shaft provided coaxially with the first input shaft, the second input shaft being configured to intermittently receive power from a power source; and a motor generator provided to transmit power to the second input shaft and receive power therefrom, wherein the first input shaft and the second input shaft, along with a separate gear shift apparatus, alternately form gear stages determined depending on a series of gear ratios, and either the first input shaft or the second input shaft forms a reverse-gear stage.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing the construction of an exemplary double-clutch powertrain according to the present invention.

FIG. 2 is a table illustrating the gear shift operation of the exemplary powertrain for a vehicle according to the present invention;

FIG. 3A is a schematic view and corresponding line graph illustrating conditions of the powertrain of FIG. 1 when it is in each gear;

FIG. 3B is a schematic view and corresponding line graph illustrating conditions of the powertrain of FIG. 1 when it is in each gear;

FIG. 4A is a schematic view and corresponding line graph illustrating conditions of the powertrain of FIG. 1 when it is in each gear;

FIG. 4B is a schematic view and corresponding line graph illustrating conditions of the powertrain of FIG. 1 when it is in each gear;

FIG. 5A is a schematic view and corresponding line graph illustrating conditions of the powertrain of FIG. 1 when it is in each gear;

FIG. 5B is a schematic view and corresponding line graph illustrating conditions of the powertrain of FIG. 1 when it is in each gear;

FIG. 6A is a schematic view and corresponding line graph illustrating conditions of the powertrain of FIG. 1 when it is in each gear;

FIG. 6B is a schematic view and corresponding line graph illustrating conditions of the powertrain of FIG. 1 when it is in each gear;

FIG. 7A is a schematic view and corresponding line graph illustrating conditions of the powertrain of FIG. 1 when it is in each gear;

FIG. 7B is a schematic view and corresponding line graph illustrating conditions of the powertrain of FIG. 1 when it is in each gear;

FIG. 8A is a schematic view and corresponding line graph illustrating conditions of the powertrain of FIG. 1 when it is in each gear;

FIG. 8B is a schematic view and corresponding line graph illustrating conditions of the powertrain of FIG. 1 when it is in each gear;

FIG. 9A is a schematic view and corresponding line graph illustrating conditions of the powertrain of FIG. 1 when it is in each gear;

FIG. 9B is a schematic view and corresponding line graph illustrating conditions of the powertrain of FIG. 1 when it is in each gear;

FIG. 10A is a schematic view and corresponding line graph illustrating conditions of the powertrain of FIG. 1 when it is in each gear;

FIG. 10B is a schematic view and corresponding line graph illustrating conditions of the powertrain of FIG. 1 when it is in each gear;

FIG. 11A is a schematic view and corresponding line graph illustrating conditions of the powertrain of FIG. 1 when it is in each gear;

FIG. 11B is a schematic view and corresponding line graph illustrating conditions of the powertrain of FIG. 1 when it is in each gear;

FIG. 12A is a schematic view and corresponding line graph illustrating conditions of the powertrain of FIG. 1 when it is in each gear;

FIG. 12B is a schematic view and corresponding line graph illustrating conditions of the powertrain of FIG. 1 when it is in each gear;

FIG. 13A is a schematic view and corresponding line graph illustrating conditions of the powertrain of FIG. 1 when it is in each gear;

FIG. 13B is a schematic view and corresponding line graph illustrating conditions of the powertrain of FIG. 1 when it is in each gear;

FIG. 14 is a schematic view showing the construction of another exemplary double-clutch powertrain for a vehicle, according to the present invention;

FIG. 15 is a schematic view showing the construction of another exemplary double-clutch powertrain for a vehicle, according to the present invention; and

FIG. 16 is a schematic view showing the construction of another exemplary double-clutch powertrain for a vehicle, according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

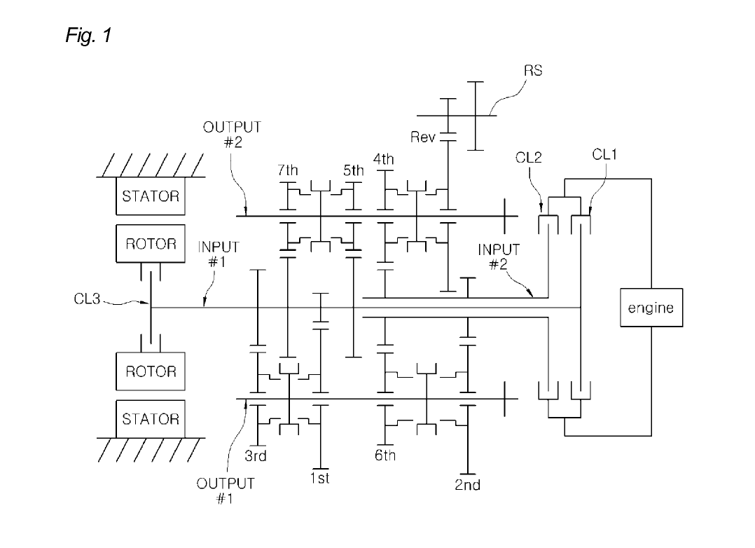

Referring to FIG. 1, a double clutch powertrain for a vehicle according to various embodiments of the present invention includes a first input shaft INPUT#1 which intermittently receives power from a power source, a second input shaft INPUT#2 which is provided coaxially with the first input shaft INPUT#1 and intermittently receives power from the power source; and a motor generator MG which transmits power to the first input shaft INPUT# 1 or receives power therefrom. The first input shaft INPUT#1 and the second input shaft INPUT#2, along with a separate gear shift apparatus, alternately form gear stages determined depending on a series of gear ratios. Either the first input shaft INPUT#1 or the second input shaft INPUT#2 can also form an R-gear stage.

In detail, the power source is an engine that is an internal combustion engine. Each of the first and second input shafts INPUT#1 and INPUT#2 is configured such that it is converted between a state capable of receiving power from the engine and an interruption state. Separately, the motor generator MG is provided such that it can transmit power to the first input shaft INPUT#1 or receive power from the first input shaft INPUT#1. Each of the first and second input shafts INPUT#1 and INPUT#2 can form gear stages in the same mechanism as that of the typical manual transmission.

The first input shaft INPUT#1 is connected to the power source by a first clutch CL1. The second input shaft INPUT#2 is connected to the power source by a second clutch CL2. The motor generator MG is connected to the first input shaft INPUT#1 by a third clutch CL3.

The motor generator MG includes a stator which is fixed in place, and a rotor which is rotatable. The rotor is connected to the first input shaft INPUT#1 by the third clutch CL3.

Of course, depending on the kind of motor generator MG, the rotor may be directly connected to the first input shaft INPUT#1 without using the third clutch CL3.

The motor generator MG is disposed coaxially with the first input shaft INPUT#1 and second input shaft INPUT#2. In other words, the motor generator MG is coaxially connected to the first input shaft INPUT#1 such that transmission of power is directly controlled by the third clutch CL3 without using an external gear between the motor generator MG and the first input shaft INPUT# 1, thus making the construction of the powertrain compact.

The separate gear shift apparatus includes a first output shaft OUTPUT#1 and a second output shaft OUTPUT#2 which are disposed parallel to the first input shaft INPUT#1 and second input shaft INPUT#2 and form the gear stages along with the first input shaft INPUT#1 and second input shaft INPUT#2 in a constant engagement synchromesh type gear shift mechanism.

That is, as shown in the drawings, the first input shaft INPUT#1, the second input shaft INPUT#2, the first output shaft OUTPUT#1 and the second output shaft OUTPUT#2 are provided therebetween with the shift gears that constantly engage with each other. The shift gears change the gear stages in such a way that connection of the shift gears to the first output shaft OUTPUT#1 or the second output shaft OUTPUT#2 is controlled by the conventional synchronizer.

The first input shaft INPUT#1 forms a first gear stage and a third gear stage between the first input shaft INPUT#1 and the first output shaft OUTPUT#1 and forms a fifth gear stage and a seventh gear stage between the first input shaft INPUT# 1 and the second output shaft OUTPUT#2. In other words, the first input shaft INPUT#1 forms odd-number-gear stages. The second input shaft INPUT#2 forms a second gear stage and a sixth gear stage between the second input shaft INPUT#2 and the first output shaft OUTPUT#1 and forms a fourth gear stage and an R-gear stage between the second input shaft INPUT#2 and the second output shaft OUTPUT#2. In other words, the second input shaft INPUT#2 forms even-number-gear stages. The first input shaft INPUT#1 and the second input shaft INPUT#2 alternately form a series of gear stages from the first to the seventh gear stages. The second input shaft INPUT#2 forms the R-gear stage along with the second output shaft OUTPUT#2 and a separate reverse idler shaft RS.

In various embodiments, the motor generator MG is configured such that it is connected to the first input shaft INPUT#1 at a position opposite to the first clutch CL1 while the gear shift apparatus including the shift gears is disposed between the motor generator MG and the first input shaft lNPUT#1.

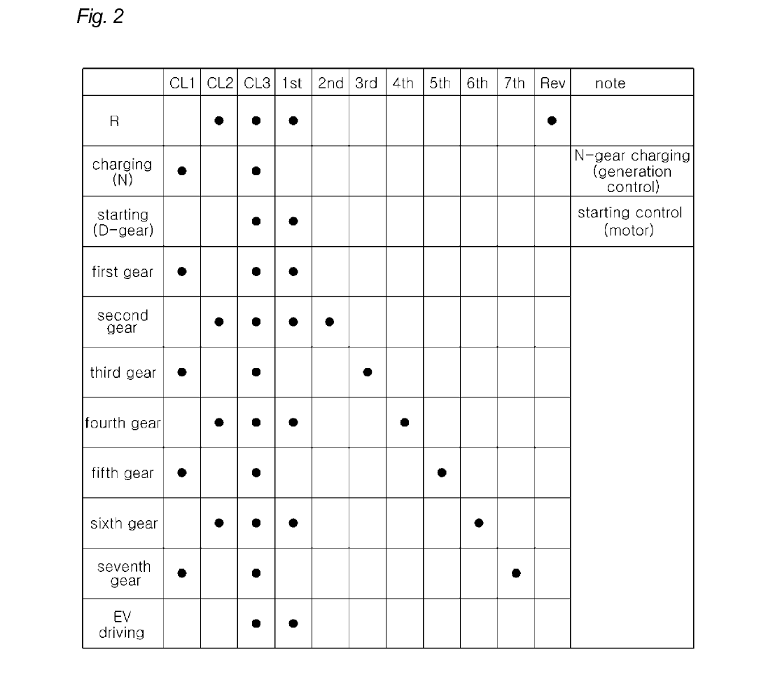

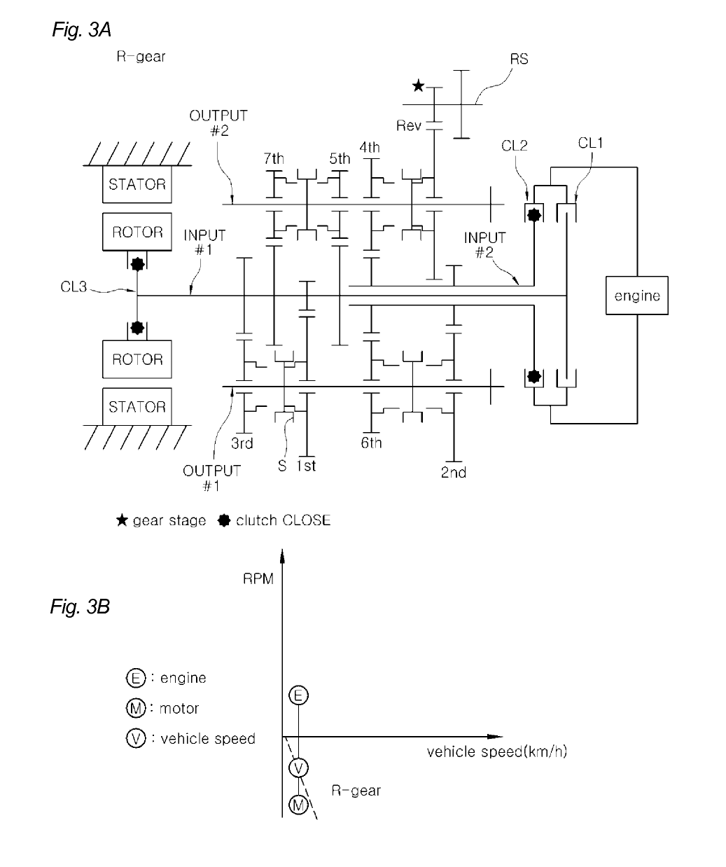

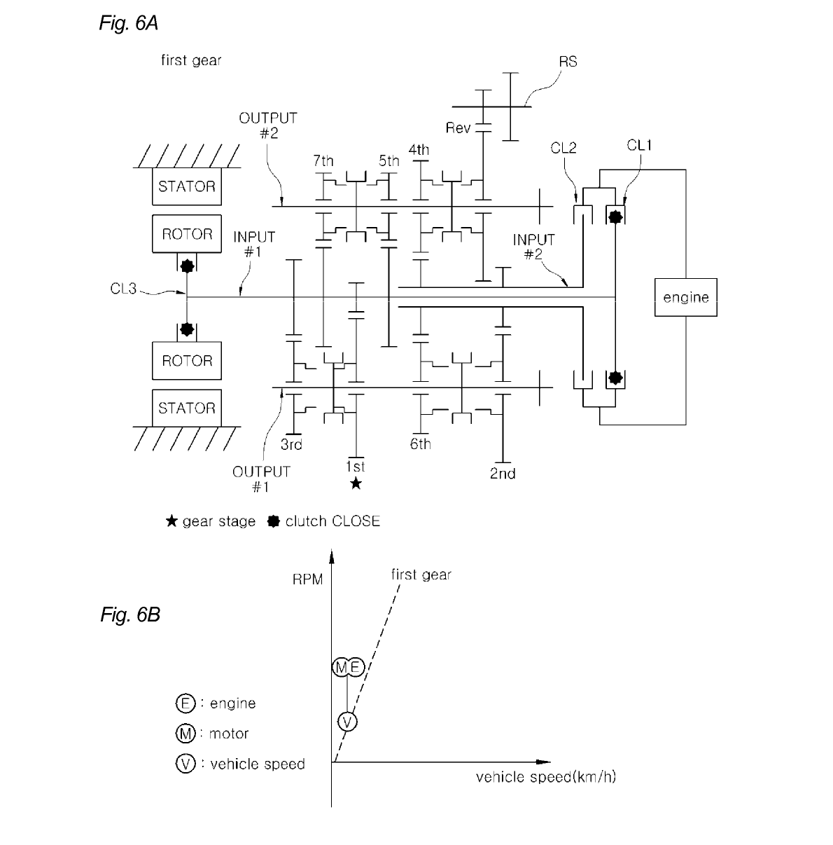

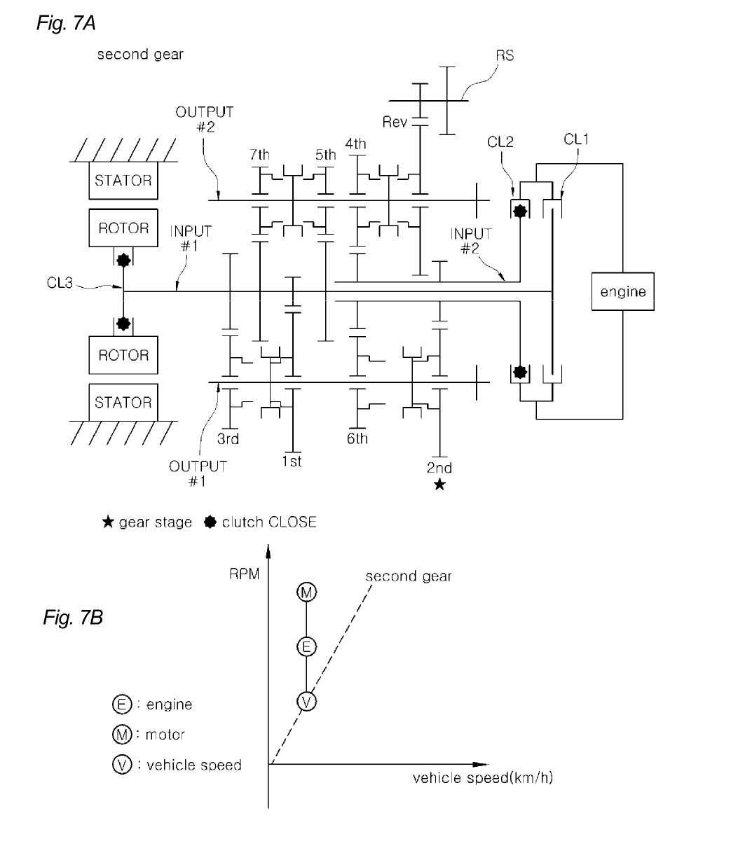

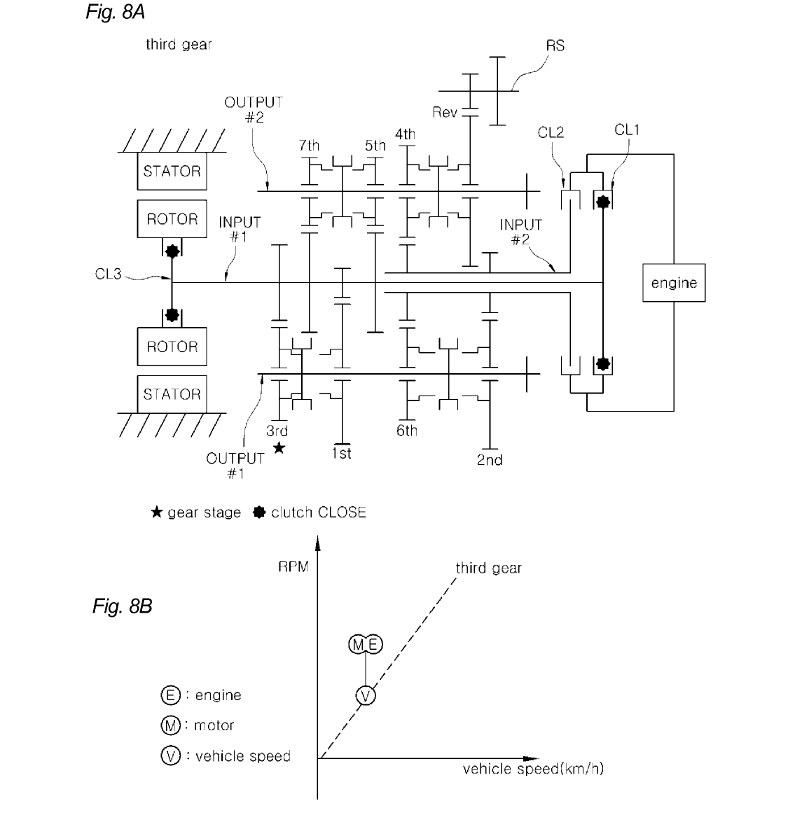

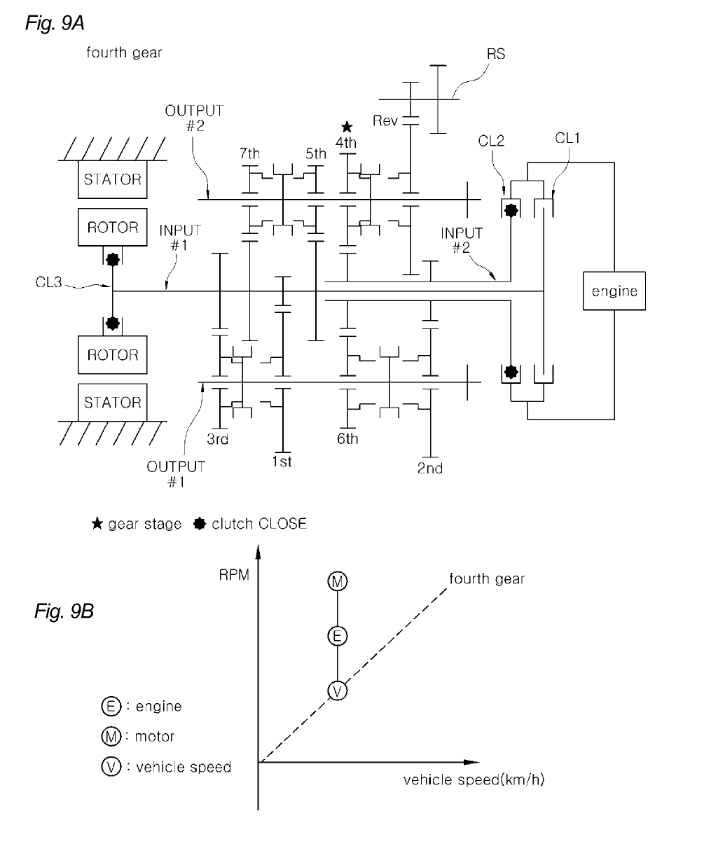

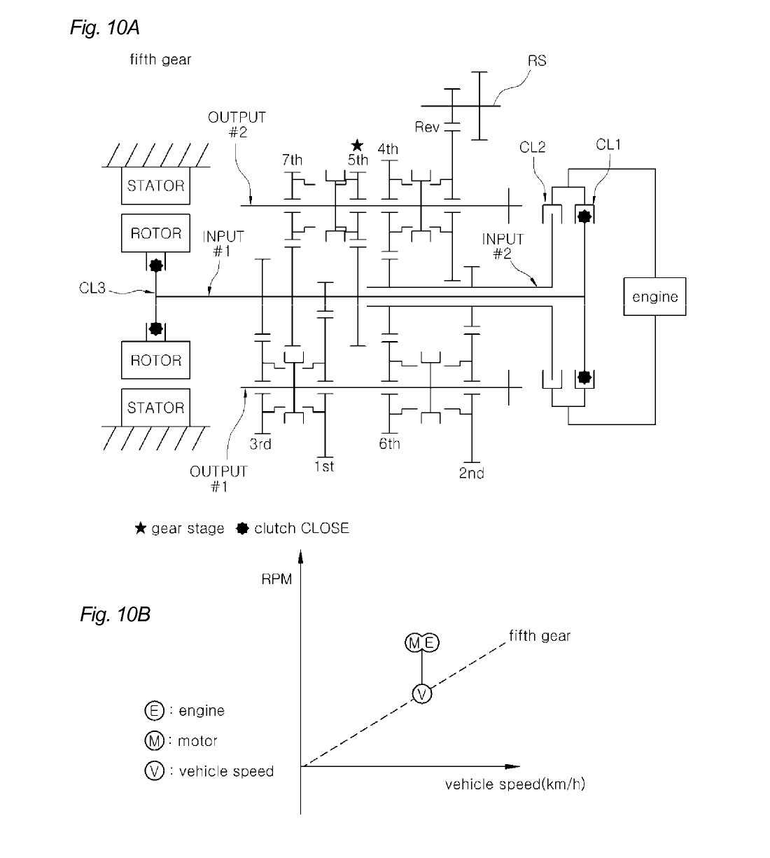

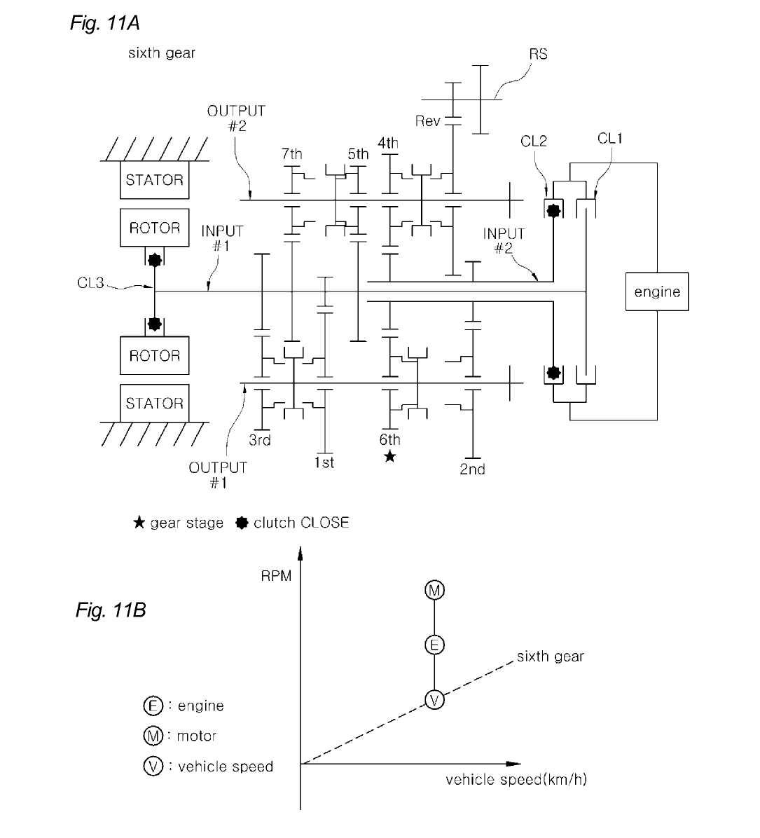

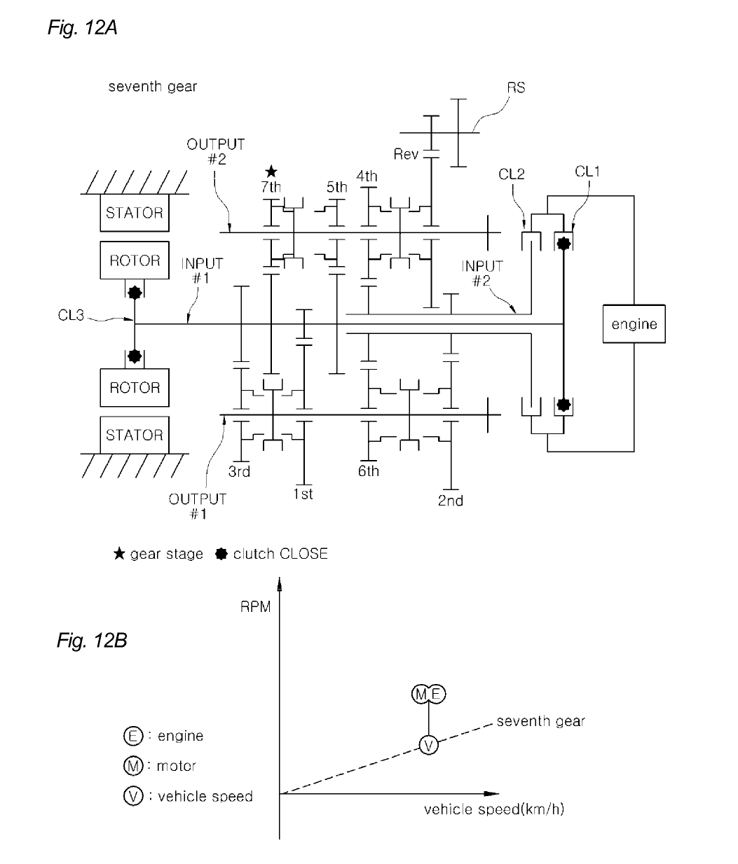

In the double clutch powertrain according to the present invention having the above-mentioned construction, as shown in the gear shift operation table of FIG. 2, the gear stages from the first gear stage to the seventh gear stage and the R-gear stage that is a reverse gear stage are embodied by selectively operating the first, second and third clutches CL1, CL2 and CL3. The formation of the gear stages is successively illustrated in FIGS. 3 through 13 with line graphs.

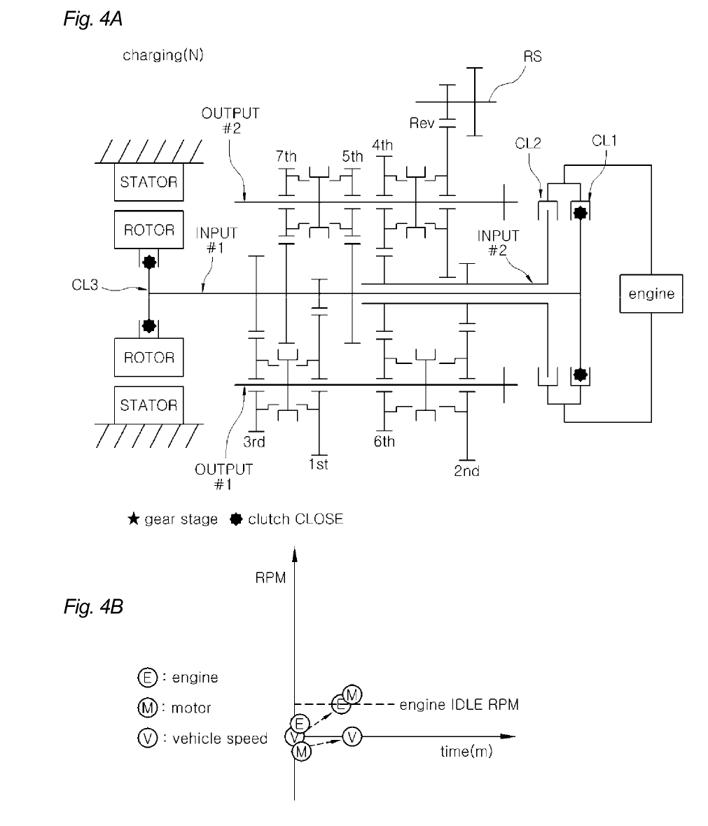

Meanwhile, the double clutch powertrain can embody an N-gear stage at which a battery can be charged with electricity generated by the operation of the motor generator MG. As shown in FIG. 4A and 4B, the first clutch CL1 and the third clutch CL3 enter the engaged states so that power generated from the engine can operate the motor generator MG through the first input shaft INPUT#1. Thereby, the motor generator MG generates electricity, thus charging a battery.

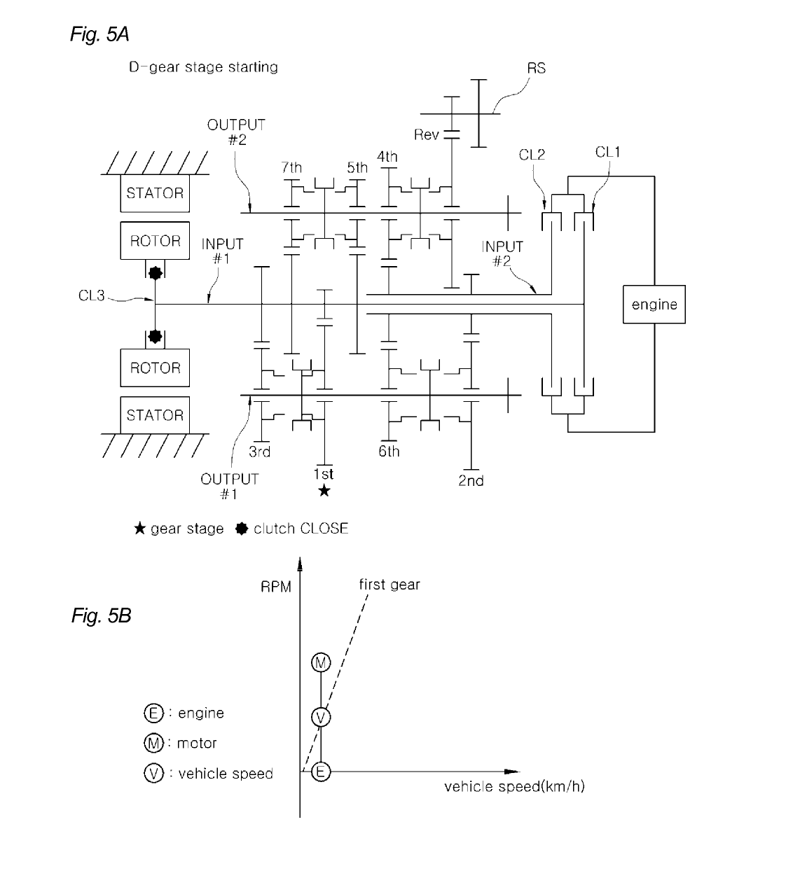

FIG. 5A and 5B illustrate an example of a D-gear stage starting of the vehicle. The vehicle is started by the power of the motor generator MG while the engine is in the stopped state. Therefore, the third clutch CL3 is in the engaged state. A synchronizer S for the first and third gear stages connects a first stage gear to the first output shaft OUTPUT#1 so that the vehicle is started by the power of the motor generator MG at a first gear ratio. Thus, the slip phenomenon of the first clutch CL1 or the second clutch CL2 can be prevented. As a result, the durability of the clutches can be maintained, and the vehicle can start smoothly and reliably.

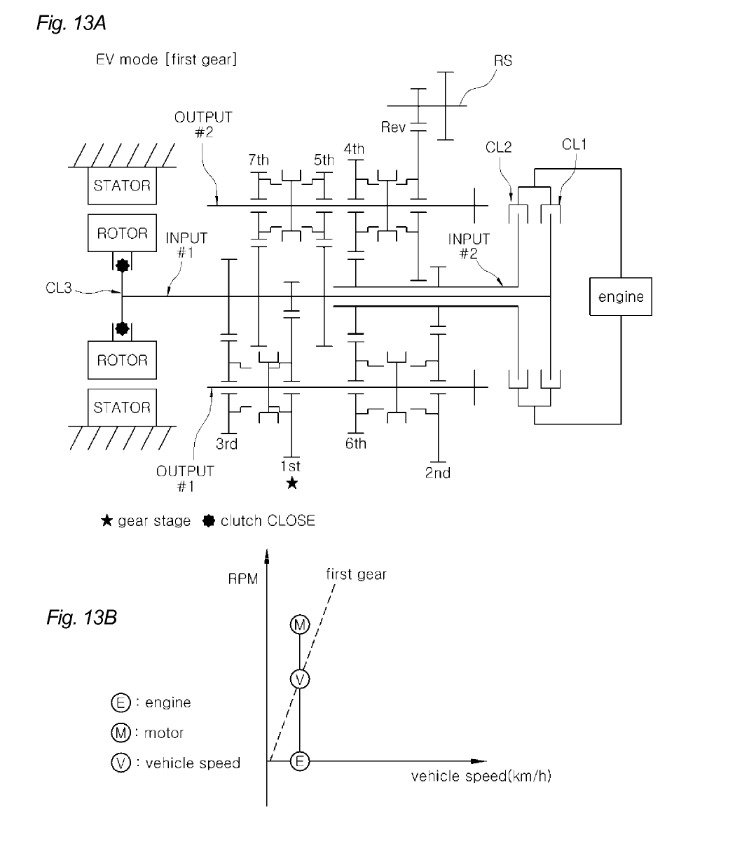

The state of FIGS. 5A and 5B is substantially the same as that of FIGS. 13A and 3B. In this case, the corresponding vehicle runs in an EV mode that is a pure electric vehicle mode. Of course, here, if another gear stage is formed by the operation of another synchronizer while the first clutch CL1 and second clutch CL2 are in the released state, the vehicle can continuously run in the EV mode at another gear stage rather than the first gear stage.

The formation of other gear stages and operation of the double clutch powertrain at each gear stage will be easily understood with reference to FIGS. 2 through 13 from the conventional double clutch transmission and manual transmission mechanism, therefore further explanation thereof will be omitted.

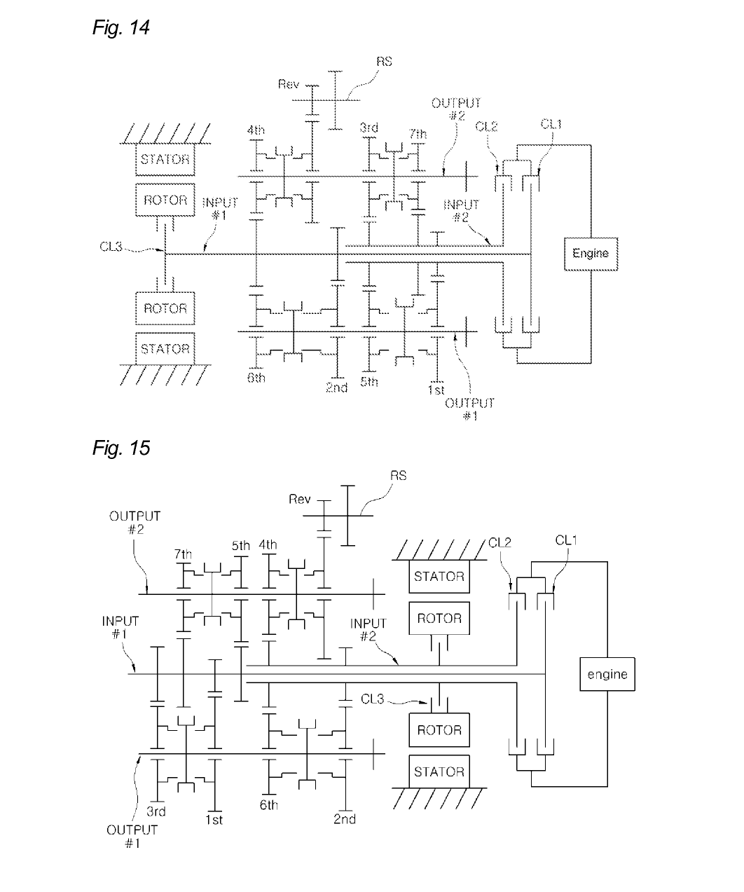

FIG. 14 illustrates an example differing with those described above in that the first input shaft INPUT#1 forms even-number gear stages including the second, fourth and sixth gear stages and the R-gear stage, and the second input shaft INPUT#2 forms odd-number gear stages including the first, third, fifth and seventh gear stages. Except for this, the construction and operation remains essentially the same as that described above.

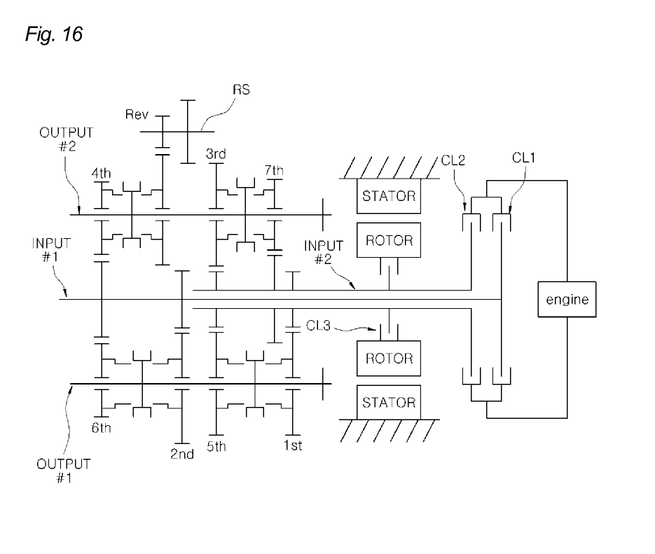

FIGS. 15 and 16 respectively illustrate various embodiments in which the motor generator MG is connected, by the third clutch CL3, to the second input shaft INPUT#2 that has a hollow shaft structure and is coaxially provided on the first input shaft INPUT# 1, rather than being connected to the first input shaft INPUT#1.

As shown in FIG. 15, the first input shaft INPUT# 1 forms the odd-number gear stages, and the second input shaft INPUT#2 forms the even-number-gear stages and R-gear stage. On the other hand, the first input shaft INPUT#1 forms the even-number gear stages and R-gear stage, and the second input shaft INPUT#2 forms the odd-number gear stages.

In various embodiments, as shown in FIGS. 15 and 16, the motor generator MG is disposed between the gear shift apparatus and the second clutch CL2, unlike some of the embodiments described above.

The operation of the various embodiments is almost the same as that described above, so detailed explanation thereof is deemed unnecessary.

As described above, a double clutch powertrain for a vehicle according to the present invention makes smooth starting of the vehicle and smooth gear shifting possible despite using a dry type double clutch and makes regenerative braking and power generation possible when the vehicle decelerates, thus improving the driving characteristics of the vehicle, and enhancing the fuel efficiency of the vehicle.

For convenience in explanation and accurate definition in the appended claims, the terms rearward and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A double clutch powertrain for a vehicle, comprising:
a first input shaft configured to intermittently receive power from a power source;
a second input shaft provided coaxially with the first input shaft and configured to intermittently receive power; and
a motor generator provided to transmit power to the first input shaft and receive power therefrom,
wherein the first input shaft and the second input shaft, along with a separate gear shift apparatus, alternately form gear stages determined depending on a series of gear ratios, and either the first input shaft or the second input shaft forms a reverse-gear stage.

2. The double clutch powertrain as set forth in claim 1, wherein the first input shaft is connected to the power source by a first clutch,
the second input shaft is connected to the power source by a second clutch, and
the motor generator is connected to the first input shaft by a third clutch.

3. The double clutch powertrain as set forth in claim 2, wherein the motor generator is provided coaxially with the first input shaft and the second input shaft.

4. The double clutch powertrain as set forth in claim 3, wherein the separate gear shift apparatus comprises:
a first output shaft and a second output shaft disposed parallel to the first input shaft and the second input shaft, the first and second output shafts forming the gear stages along with the first input shaft and the second input shaft in a constant engagement synchromesh type gear shift mechanism.

5. The double clutch powertrain as set forth in claim 4, wherein the motor generator is connected to the first input shaft at a position opposite to the first clutch while the gear shift apparatus is disposed between the motor generator and the first input shaft.

6. A double clutch powertrain for a vehicle, comprising:
a first input shaft configured to intermittently receive power from a power source;
a second input shaft comprising a hollow shaft provided coaxially with the first input shaft, the second input shaft being configured to intermittently receive power; and
a motor generator provided to transmit power to the second input shaft and receive power therefrom,
wherein the first input shaft and the second input shaft, along with a separate gear shift apparatus, alternately form gear stages determined depending on a series of gear ratios, and
either the first input shaft or the second input shaft forms a reverse-gear stage.

7. The double clutch powertrain as set forth in claim 6, wherein the first input shaft is connected to the power source by a first clutch,
the second input shaft is connected to the power source by a second clutch, and
the motor generator is connected to the second input shaft by a third clutch.

8. The double clutch powertrain as set forth in claim 7, wherein the motor generator is provided coaxially with the first input shaft and the second input shaft.

9. The double clutch powertrain as set forth in claim 8, wherein the separate gear shift apparatus comprises:
a first output shaft and a second output shaft disposed parallel to the first input shaft and the second input shaft, the first and second output shafts forming the gear stages along with the first input shaft and the second input shaft in constant engagement synchromesh type gear shift mechanism.

10. The double clutch powertrain as set forth in claim 9, wherein the motor generator is disposed between the gear shift apparatus and the second clutch.

11. The double clutch powertrain as set forth in claim 6, wherein the first input shaft embodies odd-number gear stages, such as a first gear stage, a third gear stage, a fifth gear stage and a seventh gear stage, along with the separate gear shift apparatus, and
the second input shaft embodies even-number gear stages, such as a second gear stage, a fourth gear stage and a sixth gear stage, along with the separate gear shift apparatus.

12. The double clutch powertrain as set forth in claim 6, wherein the first input shaft embodies even-number gear stages, such as a second gear stage, a fourth gear stage and a sixth gear stage, along with the separate gear shift apparatus, and
the second input shaft embodies odd-number gear stages, such as a first gear stage, a third gear stage, a fifth gear stage and a seventh gear stage, along with the separate gear shift apparatus.
